(19) United States
(12) Patent Application Publication
(10) Pub. No.: US 2002/0065588 A1
(43) Pub. Date: May 30, 2002

(54) Process and installation for automatic monitoring of aircraft during take-off or landing

(76) Inventor: Roland Johnson, Langnau am Albis (CH)

Correspondence Address: McCormick, Paulding & Huber, City Place II, 185 Asylum Street, Hartford, CT, 06103-3402, US

(21) Appl. No.: 09/977,018

(22) Filed: Oct. 12, 2001

(30) Foreign Application Priority Data
Oct. 16, 2000 (CH) 2000 2026/00

(51) Int. Cl. G06G 7/70

(52) U.S. Cl. 701/15; 701/16; 701/17

(57) ABSTRACT

A process for automatic monitoring of aircraft during take-off or landing. By means of one or more monitoring instruments installed in the vicinity of an airport shots are taken of the aircraft during take-off or landing. These recorded images are stored in a data memory. Means are present which enable the monitoring instrument to detect the aircraft and to follow the movement of the aircraft. The recorded images are stored in the data memory for later evaluation.

### CROSS REFERENCE TO RELATED APPLICATION

Applicant hereby claims foreign priority benefits under 35 U.S.C. § 119 of Swiss Application No. 2000 2026/00, filed Oct. 16, 2000, the disclosure of which is herein incorporated by reference.

### BACKGROUND OF THE INVENTION

With the increase in air traffic the problem of improving so-called air safety arises increasingly. Air safety, also known as flight safety, is understood to mean all those measures taken to make flights by aircraft safe. In the first place these are legal regulations issued by air safety authorities, which understandably also have an effect on technical facilities. These measures predominantly concern weather briefing and route planning, allocation of a so-called air route in view of permissible altitudes and take-off or landing times and monitoring of the flight plan of the aircraft being monitored. A considerable number of systems has already been developed to solve this task, which serve for example to measure distance for the purpose of preventing collisions between aircraft flying blind, for performing take-offs and landings at night or during bad weather and for creating the necessary channels of communication between the various aircraft and the control tower at an airport.

It is now the object of the present invention to contribute to solving the abovementioned task.

### SUMMARY OF THE INVENTION

The present invention relates to a process and installation for monitoring aircraft during take-off or landing by searching for image information of an aircraft during take-off or landing, automatically detecting the aircraft by processing the image information, automatically tracking the movement of the acquired aircraft by processing the image information, and storing the image information in a storage medium. Take-off and landing are the most critical phases of flying, since disproportionately many and serious incidents occur in this connection, when this is converted to the total air route travelled. The process according to the present invention gives rise to the possibility, if an extraordinary event should occur from time to time during take-off or landing, of precisely studying the aircraft in retrospect in all its external details. On the basis of observations made such incidents can possibly be avoided in the future.

The installation according to the present invention can also be used to reconstruct or examine the course and consequences of an incident.

Other advantageous embodiments of the invention will emerge from the description and the dependent claims.

The invention will now be explained hereinafter in greater detail with reference to the diagrams, in which:

### BRIEF DESCRIPTION OF THE DRAWINGS

FIG. 1 is a schematic representation of the various instruments of an installation according to the present invention;

FIG. 2A is a schematic representation of another installation according to the present invention;

FIG. 2B is a schematic representation of a monitoring group according to the present invention; and

FIG. 2C is a schematic representation of a recorded video image with field of vision, according to the present invention;

FIG. 3 is a schematic representation of a recorded video image with two fields of vision, in accordance with a further embodiment of the invention;

FIG. 4 is a schematic plan view of a further installation according to the present invention.

### DETAILED DESCRIPTION OF THE PREFERRED EMBODIMENTS

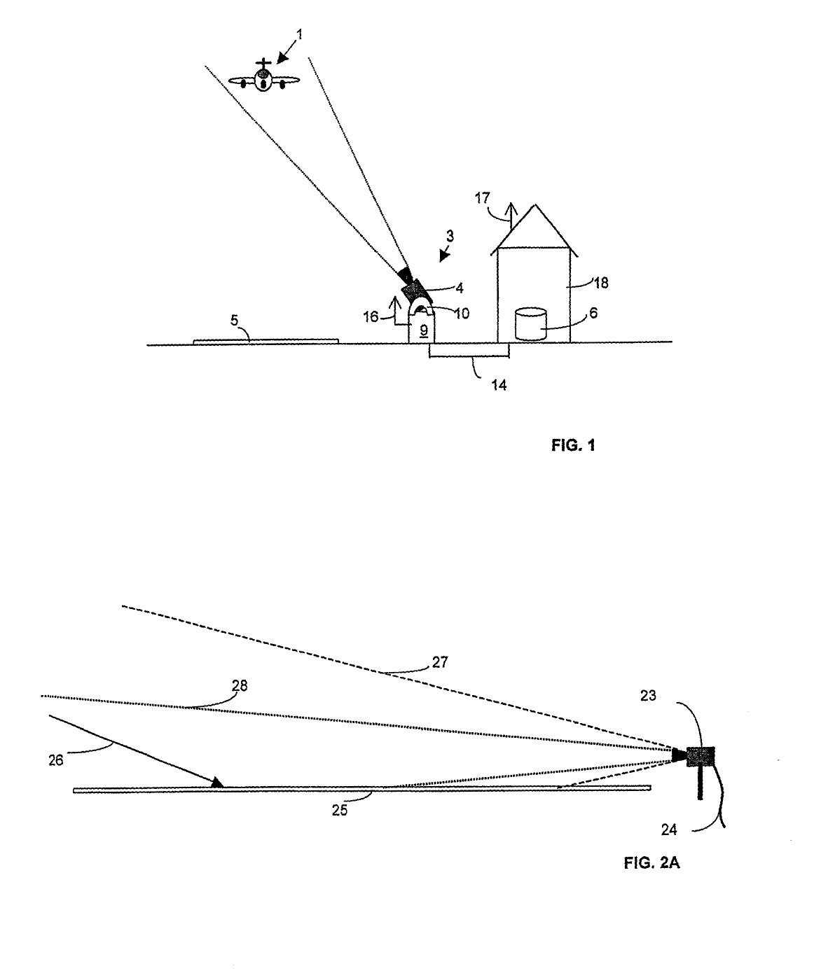

In FIG. 1 an aircraft 1 and an installation with a monitoring group 3 are illustrated by way of example. Monitoring group 3 preferably comprises a sensor device 4 which automatically acquires and tracks a target to be tracked (e.g. an aircraft 1 taking off). In the illustrated example a camera (TV camera and/or infrared camera) 4 serves as a sensor device. This camera 4 has a control system 10 which enables camera 4 to move. With monitoring group 3 a system can be realised, in which aircraft 1 is detected automatically (acquisition) by camera 4 and thus camera 4 is accordingly aimed at aircraft 1. Then camera 4 automatically follows the movements of aircraft 1 (tracking). The necessary adjusting movement of camera 4 is determined and controlled by means of corresponding software which is located in monitoring instrument 9, for example. This function can also be realised in analogue technology. The software regulates control system 10 to ensure that aircraft 1 remains in the field of view of camera 4. As aircraft 1 continues to move the alignment of camera 4 and possibly of the zoom is matched by a controlled shift of control system 10. Camera 4 preferably forms a closed loop with the software and control system 10, enabling automatic detection and tracking of aircraft 1. In the example according to FIG. 1 the installation according to the present invention comprises only one monitoring group 3 located on the right side of a runway 5.

In the illustrated embodiment of the invention shots of an aircraft 1 can automatically be registered and stored. The corresponding video signals generated by camera 4 can be transmitted via a cable 14 for example, or via radio by means of antenna pair 16 and 17, to a remote monitoring site 18. Monitoring site 18 can preferably be equipped with a video system 6 for storing the video signals. In a further embodiment the image information can be transmitted from camera 4 to monitoring site 18 in the form of digital signals. In such a case the best solution is to record the digital signals by means of a computer.

The image signals can also be stored locally in monitoring group 3 or in a camera.

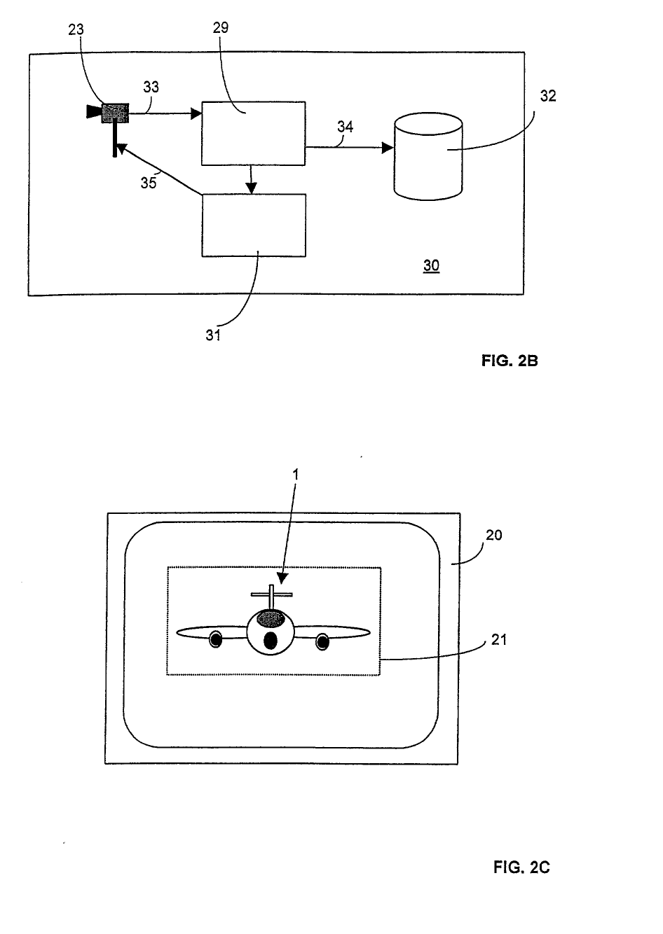

FIGS. 2A to 2C illustrate a further embodiment of the present invention. In the illustrated example a camera 23 (TV camera and/or infrared camera) is positioned at the end of a runway 25. TV camera 23 is part of a TV tracking and/or acquisition system. For this TV camera 23 to be best able to track an aircraft during the approach sequence and landing, it is preferably equipped with an automatic zoom lens. FIG. 2A illustrates a guide beam 26 which the aircraft follow in their landing approach. The zoom lens of camera 23 is of such a size that an aircraft already in the approach sequence has reached its largest size in the field of view of camera 23. In this starting position the zoom lens has a narrow angle of aperture and visual range is limited, for example—as indicated diagrammatically in FIG. 2A—by a conical range 28. In this starting position the aircraft can be recorded in spite of being a greater distance from camera 23. As the aircraft approaches runway 25 the zoom lens is continually adjusted automatically to furthermore be able to keep the approaching aircraft in the field of view of camera 23 also at an almost constant playback size. As the zoom is continually adjusted the angle of aperture of the camera is enlarged, as represented by conical area 27. Therefore approaching aircraft also can be fully acquired in the field of view of camera 23. Camera 23 can be connected by way of connecting cables 24 to a monitoring group 30.

The block flow diagram of a monitoring group 30 according to the present invention is illustrated in FIG. 2B. Camera 23 delivers image signals via a connection 33 to an acquisition system 29. This acquisition system 29 evaluates the image signals of camera 23 to determine whether an aircraft is within the field of view of camera 23. For this purpose a viewing window 21 (called a gate) can de defined, for example, on a monitor 20, as illustrated in FIG. 2C. Acquisition system 29 supplies signals to a regulating system 31. From these signals this regulating system 31 establishes a correcting variable which is used to control the positioning of camera 23 and the zoom lens of camera 23. Acquisition system 29 ascertains whether the image of aircraft 1 lies inside viewing window 21. As aircraft 1 approaches runway 25 it would become larger and larger in image 20. As the zoom-out angle is increased the image size of aircraft 1 is reduced. By means of video tracker 29 and of regulating system 31 a closed loop can be formed which automatically keeps the image size of aircraft 1 within the limits of viewing window 21. It should be noted that camera 23 acts as a sensor enabling acquisition and tracking. In addition, camera 23 can supply image signals which can be recorded. Camera 23 is used together with video tracker 29 to acquire and track aircraft 1.

Such video trackers are known from military applications, for example. The video trackers employed in a military context are adjusted manually or semi-automatically to an object to be tracked and then take over the automatic tracking of this object. In connection with the present invention acquisition occurs automatically. This is possible because the position of an aircraft taking off or landing is known relatively precisely. Camera 23 can thus be brought into a starting position where it waits until an aircraft is acquired in the field of view. From this point on video tracker 29 can automatically track the aircraft by controlling camera 23 (by enlarging or reducing the zoom-out angle, inclining and/or rotating camera 23).

In embodiments of the invention, where several cameras which are networked with one another are employed, the video tracker can deliver correction variables, by means of which the other cameras automatically follow the movement of the aircraft. The video tracker thus controls the movement and adjustments of the other cameras.

In the example shown in FIG. 2B video tracker 29 is connected via a cable 34 to a recording medium 32 (e.g. a video system). By way of this cable 34 video tracker 29 forwards image signals to recording medium 32, where said signals are stored.

In a further embodiment of the invention camera 23 contains a regulating system which enables camera 23 to move. Ideally a control system is used which permits camera 23 to rotate and/or incline. Such a control system allows further degrees of freedom to detect, track and record a landing aircraft 1. This type of control system can be equipped with one or more servomotors.

Monitoring group 30 usually includes software which controls and checks the abovedescribed procedures.

A similar embodiment of the invention can be placed on a take-off runway for tracking and recording aircraft during the acceleration and take-off phase.

A further embodiment of the invention can include a TV camera and an infrared camera. Accordingly, inter alia the take-off or landing of an aircraft can also be acquired and recorded when visibility conditions are unfavourable and in darkness. Both cameras can also be linked to the video tracker.

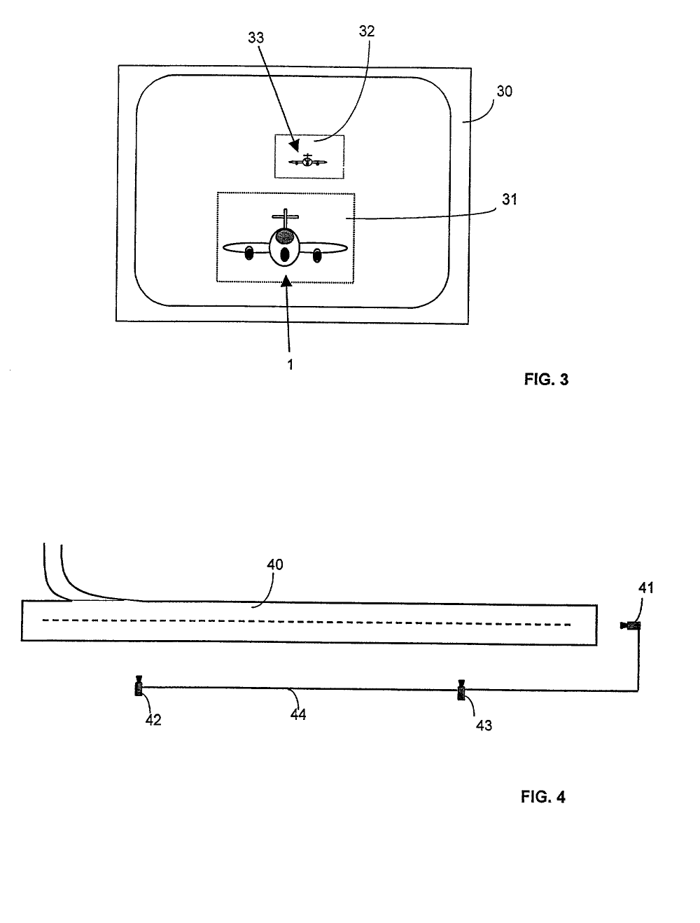

The monitoring group can be configured such that more than one viewing window (gate) can be defined in the image. An example is illustrated diagrammatically in FIG. 3. In the illustrated example the system operates with two viewing windows 31 and 32. Two aircraft 1 and 33, which are successively approaching a landing strip, are visible on monitor 30. First viewing window 31 is larger than second viewing window 32 and in the illustrated example includes that aircraft 1 which is in the final phase of the landing sequence. The installation can be configured such to enable automatic switching to second viewing window 32. Such a system enables rapid automatic switching to another aircraft 33.

A monitoring group can be complemented by more cameras and/or sensors which are set up to the side of the runway, for example. The monitoring group can also be complemented by an observation camera located at an appropriate point in the vicinity of the airport, on the control tower, for instance.

An installation according to the present invention can additionally include a camera which monitors the landing strip vicinity where aircraft usually touch down.

In general an installation according to the present invention can comprise two or more (preferably computer-controlled) monitoring groups or one monitoring group with several cameras, which are located at appropriate points in the environs of an airport. Such an arrangement is illustrated diagrammatically in FIG. 4. FIG. 4 shows a take-off runway 40 at the end of which a camera 41 is located. This camera is linked to two other cameras 42 and 43 by way of cables 44. Cameras 41, 42, and 43 are connected to a video tracker (not illustrated in FIG. 4). Similarly to the foregoing embodiments they are structured such that an aircraft can be acquired, tracked and recorded automatically during take-off.

Special sensors can be used to check the commencement or end of recording. Induction loops in the runway for example can be used to detect whether an aircraft leaves the runway after a successful landing to taxi in the direction of a parking bay. In the process the aircraft travels over the induction loop and recording of images is terminated. Light barriers and other means can also be used for this purpose. Similar means can be employed to determine the beginning of recording for a plane taxiing to the take-off position.

After take-off is completed recording can be stopped for example, as soon as transfer is made from ground control to airspace control. For this purpose the installation according to the present invention can receive a control signal from the airport control tower, for example.

Storing the image information preferably occurs endlessly, that is, these image signals are overwritten after a predetermined period T1, for example continually after a normal landing is completed or after a predetermined number of hours or days. Apart from such automatic deletion of the image signals manual deletion can be employed in addition. In the central monitoring position a monitor 20 can also be present to repeatedly observe and study the registered or stored scenes. Deletion of the take-off phase, however, should occur at the earliest after the aircraft lands at its destination.

The recordings made by the monitoring group can be stored in data memory (video cassette, computer hard drive, optical storage media, etc.).

In a further configuration of the invention video tracker 29 is designed such that it puts out a warning signal after an unusual image pattern is received. The system can then for example give the command to cease deleting recording during a period before and after this warning signal, and to treat them separately. Such a warning signal can also be generated by a particularly bright image in one of the cameras. For this purpose the light intensity, for example, can be determined and compared with a threshold value.

The present invention can be used advantageously to analyse problematical incidents (aborted take-off, engine or undercarriage problems, accidents, etc.). Such analysis can contribute to making air traffic safer, as lessons can be drawn from the recorded information. A recording can also be used to investigate a take-off or landing. Accordingly it is possible for example to assess the details of an incident relatively quickly and neutrally, in particular also if the information from the flight recorder and the voice recorder from the corresponding aircraft is evaluated at the same time.

The system according to the present invention can be equipped with software such that the video tracker can process two or more gates, in such a way that each of these gates is assigned to an aircraft. In a further embodiment the video tracker can automatically determine which of the gates takes precedence over the other gates. This gate is designated as the determining gate. An aircraft can thus be detected and tracked, even though another aircraft has already been detected. If several cameras are present control information is supplied to these cameras so that they can follow the aircraft which was captured in the determining gate.

The system according to the present invention can be complemented by an auxiliary unit, which allows the image information captured by the acquisition system to be evaluated in order to search for predetermined silhouettes or patterns in the overall image area. This auxiliary unit enables specific aircraft to be searched for, in that features which characterise the aircraft are searched for in the image information. This effectively prevents the installation according to the present invention from locking onto false targets (e.g. birds). For this, the image information is preferably digitised and then processed. This auxiliary unit, however, can also be used to buffer certain characterising video features from an aircraft, once it has been detected. By means of this buffered information and with the aid of information on movement, the video tracker can continue to follow the aircraft, even when it is momentarily obscured by a cloud or other obstacles, for example.

According to the invention the installation can automatically be locked on as soon as an aircraft has been acquired.

Preferably the size of the video tracker gates is variable. To be able to best track the acquired aircraft the video tracker plots the size and/or position automatically.

The image signals, supplied by the video tracker, are preferably filtered and digitised. The digitised data are then forwarded to an image-processing unit (e.g. in the form of a computer). The image-processing unit extracts target data by means of which target tracking (tracking) can be effected.

In another embodiment the video tracker has a first gate which can be directed for example at the guide beam of an airport to detect aircraft which approach the airport along the guide beam. The gate directly follows the movements and fluctuations of the aircraft. By comparison, the camera slowly follows the gate movement so as to keep the gate in the middle of the image as far as possible. Small movements of the aircraft are captured by a movement made by the gates, without the camera having to move. Another gate can be provided which is in a position to acquire and track aircraft which are not moving along the guide beam.

For data protection reasons the installation according to the present invention can be designed such that only authorised persons, such as those from a recognised supervisory body, can gain access to the recordings.

In a further embodiment the installation comprises one or more microphones, so that the monitoring instrument can intercept and evaluate audio signals. Furthermore, the installation can be equipped with mobile cameras which can be moved by 2 or more degrees of freedom. According to a further embodiment the image signals can be recorded by several of the cameras. The monitoring installation can also be locked on, whenever the acquisition system has identified an aircraft.

For better evaluation of the recordings at the same time as the video image a time signal, such as GMT time and possibly the date, can be acquired.

The installation according to the present invention can either be mounted stationary, or it can be configured as a mobile facility. Such a mobile embodiment is particularly suitable for military deployment or for temporary use.

What is claimed is:

1. A process for monitoring aircraft, characterised in that monitoring is carried out with a monitoring instrument (3; 23, 30) including an acquisition system installed in the vicinity of a take-off or landing strip, with the following steps being carried out:
searching for image information of an aircraft (1) during take-off or landing,
automatic detection of the aircraft (1) by processing the image information,
automatic tracking of the movement of the acquired aircraft (1) by processing the image information, and
storing the image information in a storage medium (6; 32).

2. A process as claimed in claim 1, characterised in that the monitoring instrument (3) contains a separate sensor which detects or acquires information on the position of the aircraft (1), and forwards this to the monitoring instrument (3; 23, 30) in order to have the latter automatically follow the movement of the aircraft (1).

3. A process as claimed in claim 1 or 2, characterised in that a video system or a computer system serves as a storage medium.

4. A process as claimed in any one of claims 1 to 3, characterised in that the monitoring instrument (30) comprises a camera (23), preferably a TV camera and/or an infrared camera.

5. A process as claimed in claim 4, characterised in that the camera (23) includes an automatically controlled zoom lens whose angle of aperture can be adjusted.

6. A process as claimed in any one of claims 1 to 5, characterised in that the acquisition system (29) processes the image information to keep the aircraft (1) in a monitoring space of the monitoring instrument (30).

7. A process as claimed in claim 6, characterised in that the acquisition system (29) supplies a corrective signal to accordingly control the monitoring instrument (30).

8. A process as claimed in claim 6 or 7, characterised in that the acquisition system (29) puts out a warning signal when it recognises an unusual image pattern.

9. A process as claimed in any one of the foregoing claims, characterised in that the monitoring instrument (30) forwards signals to other mobile cameras to have these other cameras automatically follow the movement of the aircraft (1).

10. A process as claimed in any one of the foregoing claims, characterised in that the monitoring instrument (30) acquires and evaluates audio signals.

11. A process as claimed in claim 9, characterised in that the mobile cameras can be moved by 2 or more degrees of freedom.

12. A process as claimed in claim 9, characterised in that the image signals are recorded by several of the mobile cameras.

13. A process as claimed in any one of the foregoing claims, characterised in that the monitoring instrument (30) processes the image information to prevent false targets from being tracked.

14. A process as claimed in any one of the foregoing claims, characterised in that the monitoring instrument (30) processes the image information in order to only activate when the acquisition system has recognised a aircraft.

15. An installation for monitoring aircraft on take-off and/or landing on a take-off or landing strip, characterised in that a monitoring instrument (3; 23, 30) having an acquisition system and a storage medium (6; 32) is installed in the vicinity of the take-off or landing strip (5; 25), such that the installation prepares and evaluates image information in order to search for an aircraft (1) using the image information, automatically detect the aircraft (1), automatically follow the movement of the aircraft (1), and in the process store the image information, acquired from automatically tracking the aircraft (1), in the storage medium (6; 32).

16. An installation as claimed in claim 15, characterised in that the installation has a separate sensor which supplies signals on the position of the aircraft (1) in order to control the monitoring instrument (3) according to these signals.

17. An installation as claimed in any one of claims 15 or 16, characterised in that it comprises several monitoring instruments (3) and/or cameras (41, 42, 43) which are linked to one another and can be moved by signals from the acquisition system (29).

18. An installation as claimed in claim 15, 16 or 17, characterised in that a video system or a computer system acts as storage medium (6; 32).

19. An installation as claimed in any one of claims 15 to 18, characterised in that the monitoring instrument (30) comprises a camera (23), preferably a TV camera and/or an infrared camera.

20. An installation as claimed in claim 19, characterised in that camera (23) has a zoom lens whose angle of aperture can be adjusted automatically.

21. An installation as claimed in any one of claims 15 to 20, characterised in that the acquisition system (29) processes the image information to keep the aircraft (1) in a predetermined monitoring space (21) of the monitoring instruments (30).

22. An installation as claimed in any one of claims 15 to 21, characterised in that it is designed to store peripheral auxiliary data, such as date and/or time.

23. An installation as claimed in any one of claims 15 to 22, characterised in that it comprises means for automatic switching on and/or for switching off, such that these means can be triggered directly or indirectly by the aircraft (1).

24. An installation as claimed in any one of claims 15 to 23, characterised in that it is installed either in the vicinity of an airport, an airfield, or on an aircraft carrier.

25. An installation as claimed in any one of claims 15 to 24, characterised in that the monitoring instrument (30) intercepts and evaluates audio signals.

26. An installation as claimed in claim 17, characterised in that the mobile cameras can be moved by 2 or more degrees of freedom.

27. An installation as claimed in claim 17, characterised in that the image signals are recorded by several of the mobile cameras.

28. An installation as claimed in any one of claims 15 to 27, characterised in that the monitoring instrument (30) processes the image information in order to prevent false targets from being tracked.

29. An installation as claimed in any one of claims 15 to 28, characterised in that the monitoring instrument (30) processes the image information in order to only activate when the acquisition system has recognised an aircraft.
